(19) United States
(12) Patent Application Publication
(10) Pub. No.: US 2015/0152278 A1
(43) Pub. Date: Jun. 4, 2015

(54) PVC-ACRYLATE BLENDS

(71) Applicant: PolyOne Corporation, Avon Lake, OH (US)

(72) Inventors: John Tresino, Findlay, OH (US); Brent Cassata, Findlay, OH (US)

(73) Assignee: PolyOne Corporation, Avon Lake, OH (US)

(21) Appl. No.: 14/409,699

(22) PCT Filed: Jun. 18, 2013
(86) PCT No.: PCT/US13/46357

§ 371 Date: Dec. 19, 2014

Related U.S. Application Data
(60) Provisional application No. 61/663,255, filed on Jun. 22, 2012.
(60) Provisional application No. 61/707,507, filed on Sep. 28, 2012.
(60) Provisional application No. 61/746,546, filed on Dec. 27, 2012.

(51) Int. Cl. C09D 127/06; C09D 7/12

(52) U.S. Cl. CPC C09D 127/06; C09D 7/1241; C09D 7/1233

(57) ABSTRACT

A blend is disclosed comprising polyvinyl chloride (PVC) powder and trimethylolpropane trimethacrylate. This acrylate unexpectedly provides a very nice melt flux state during use in fluidized bed powder coating apparatus. The use of this acrylate in some embodiments allows a reduction of PVC and plasticizer in the blend. Coated metal articles using the blend include appliance components, outdoor furniture, and automotive parts.

### CLAIM OF PRIORITY

This application claims priority from U.S. Provisional Patent Application Ser. No. 61/663,255 bearing Attorney Docket Number 12012008 and filed on Jun. 22, 2012, U.S. Provisional Patent Application Ser. No. 61/707,507 bearing Attorney Docket Number 12012020 and filed on Sep. 28, 2012, and U.S. Provisional Patent Application Ser. No. 61/746,546 bearing Attorney Docket Number 12012026 and filed on Dec. 27, 2012 all of which are incorporated by reference.

### FIELD OF THE INVENTION

The present invention relates to blends of polyvinyl chloride (PVC) powders and acrylates useful for making solid coatings on metallic substrates.

### BACKGROUND OF THE INVENTION

Over the past several decades, the use of polymers has transformed the world. Polymer science has rapidly evolved to make thousands of different thermoplastic and thermosetting products within the four corners of polymer physics: thermoplastic plastics, thermoplastic elastomers, thermoset plastics, and thermoset elastomers.

No large scale production of any polymer or articles therefrom can rest on current ingredients or processing conditions. Reduction of cost, improvement of productivity, delivery of better performing, lower cost products all drive the polymer science industry. With the advent of new materials and associated processes, it is often beneficial to replace older polymeric materials with materials having improved properties, processing capabilities, and/or processing efficiencies in particular applications and associated processes.

Not only are further materials desired, but efficient and replicable methods for production of articles therefrom are also desired. A wide variety of processes are known for the manufacture of polymeric components such as those described above.

Fluidized bed processing of polymeric powder blends is well known and a commercially practical means of converting powder into a solid coating on the substrate, usually metallic. With such technique, a polymer-coated metallic part can be formed. The polymer not only provides a different surface for handling but also protects the underlying metallic substrate from deterioration, such as oxidation which causes rusting and loss of strength.

### SUMMARY OF THE INVENTION

The powders of PVC are combined with acrylates to make a blend useful for fluidized bed powder coating processes. Significantly, the blends of the invention essentially exclude calcium zinc heat stabilizer and phosphite processing aids, which are otherwise often present in conventional PVC powder coating mixtures.

One aspect of the present invention is a polymeric blend, comprising (a) polyvinyl chloride powder; (b) trimethylolpropane trimethacrylate; (c) plasticizer; (d) octyl tin heat stabilizer; and (e) liquid epoxy resin; wherein the blend is essentially excludes calcium zinc heat stabilizer and phosphite processing aids.

Another aspect of the present invention is a coated metallic article made using the powder blend described above.

A variety of articles can be prepared from thermoplastic powder blends of the invention. Any metallic article capable of being coated in a fluidized bed powder coating apparatus is a candidate for coating by the blends of the invention.

### EMBODIMENTS OF THE INVENTION

### Blend Ingredients

Polyvinyl chloride is the principal ingredient of the blend. Any PVC suspension or dispersion resin manufactured in or converted into a powder form is a candidate for use in the present invention. PVC powder is a well known and well accepted resin for use in powder coating processes identified above. Average particle sizes for such candidate PVC powders can range from about 40 micrometers (μm) to about 400 micrometers and preferably from about 100 micrometers to about 250 micrometers.

Commercially available PVC polymers in powder form include GEON™ brand PVC resins from PolyOne Corporation. GEON™ PVC resin is presently preferred.

To provide flexibility and plasticization of the PVC resin, plasticizers can be used. Plasticizers generally are esters of both petrochemical origin, such as phthalates, and biological origin, such as citrates, fatty acid esters, etc. Of those plasticizers of biological origin, epoxidized vegetable oil is presently preferred, especially epoxidized soybean oil, such as commercially available as Plas-Chek™ brand plasticizers from Ferro Corporation.

Significant to the blends of the present invention is the use of particular acrylate, namely trimethylolpropane trimethacrylate, to provide further modification to the base PVC resin.

Those of ordinary skill in the art would expect the addition of an acrylate to the powder blend to inhibit the melt properties of the blend. However, reduction of use of plasticizer and the use of the acrylate have unexpectedly resulted in a powder blend which exhibits a very nice melt flux state for the blend before the acrylate undergoes crosslinking.

Moreover, during the curing process, sufficient cross linking occurs in the blend, which minimizes and preferably eliminates melt dripping tendencies for the powder blend during fluidized bed coating. The blend cures to provide a hard self-bonded PVC-based coating on to the metal substrate chosen for forming the coated article.

Also unexpectedly, in some embodiments, the use of the acrylate permitted the blend to have about 28% less PVC in the blend than is conventionally used for PVC powder coating mixtures. Thus, in these embodiments, both PVC and plasticizer are reduced in content in these blends because of the addition of the trimethylolpropane trimethacrylate, and the unexpected properties which that acrylate brings to the powder blend.

Other ingredients in the blend can include, for example, internal and other lubricants, flow agents, heat stabilizers, light stabilizers, pigments (e.g., carbon black), antioxidants, plasticizers, fillers (e.g., talc and CaCO₃), and mattening agents (e.g., polyurea powders and various silicas). Those skilled in the art can, without undue experimentation, select various components and various amounts of other components to fulfill desired properties.

But also, unexpectedly, it has been found that certain conventional ingredients are to be essentially excluded from the blends. Specifically, it has been found that no calcium zinc heat stabilizer should be used in the blends of the invention. Also, it has been found that no phosphite processing aid should be used in the blends of the invention.

Acceptable ingredients include pigments, such as titanium dioxide or channel black, weathering additives, such as liquid epoxy resins which are commercially intended for use embedding and potting of electronic components, processing aids, such as a fine grained microsuspension PVC homopolymer which provides the finished powder blend with good flow characteristics.

Table 1 shows acceptable, desirable, and preferable ranges of ingredients useful in the present invention, all expressed in weight percent (wt. %) of the entire compound. The compound can comprise, consist essentially of, or consist of these ingredients.

TABLE 1

| Ingredient (Wt. Percent) | Acceptable | Desirable | Preferable |
|---|---|---|---|
| PVC Resin | 50-80% | 55-80% | 60-80% |
| Plasticizer | 0.1-12% | 0.1-12% | 1.5-12% |
| Trimethylolpropane | 0.40-50% | 0.40-40% | 0.4-26% |
| Trimethacrylate | | | |
| Octyl Tin Heat Stabilizer | 0.1-5% | 0.1-2% | 1-2% |
| Rutile titanium dioxide pigment | 0-10% | 0-5% | 2-4% |
| Microsuspension PVC | 0-10% | 0.1-5% | 2-4% |
| homopolymer | | | |
| Liquid epoxy resin | 0.1-10% | 0.1-5% | 2-4% |

### Formation of Powder Blend

A heated mixer, such as a Henschel high intensity mixer, can be used to thoroughly mix the ingredients of the blend.

The blending begins with the addition of the PVC resin, any plasticizer, the heat stabilizer, pigment(s), and liquid epoxy resin. After these ingredients are heated and mixed, at about 86° C., the trimethylolpropane trimethacrylate is added. Heating and agitation continues until the temperature reaches about 100° C. At that point, the contents of the Henschel are discharged or “dropped” into a cooling mixer with the microsuspension PVC homopolymer being added at about 60° C., followed by continued cooling and mixing until about 30° C. when the completed mixed contents are discharged or “dropped”, are filtered through a 40-mesh screen, and are ready for use in fluid bed processing equipment as a powder blend.

### Powder Coating Using Fluidized Bed Technique

According to the fluidized bed technique, heated metal parts are dipped in an aerated bed of the powdered composition. The powder melts on the heated part, resulting in a smooth continuous film encapsulating the metal. This process takes place in what is referred to as a “fluidized bed.” The fluidized bed has three main sections: (1) a top powder hopper where the powder is held, (2) a porous plate that allows air to pass through, and (3) a sealed bottom air chamber. When pressurized air is blown into the air chamber, it passes through the plate and causes the powder to float or “fluidize”. This fluidization allows the metal part to be coated and moved through the powder with little resistance during the dipping process.

Alternatively, a cold substrate can be run over a bed of fluidized particles that are tribo-charged and, thus, cling to the substrate. The coated substrate can then be passed through a heated zone, or nip, to fuse the coating.

Processes for preparing articles from the blends identified above can include not only fluidized bed powder coating techniques, but also high velocity impact fusion, electrostatic spray, thermal spray, slush molding, or rotational molding techniques.

### Usefulness of the Invention

Starting with the concept that any metal article is candidate for being coated and protected by a PVC-acrylate blend coating, those having ordinary skill in the art can market this blend into industries ranging from automotive to commercial to consumer goods. Nonlimiting examples include appliances such as racks and other components for dishwashers, agitators and tubs for washing machines, etc. With the coating providing aesthetic advantages, and being capable of being pigmented, particular suitable uses of the blends are automotive parts, outdoor furniture, fixtures, or construction embellishments for homes or industrial buildings, limited in possibility only by the vision of architects and other designers.

Further embodiments and applications of the invention are described in the following non-limiting examples.

### EXAMPLES

### Comparative Examples A-D and Examples 1 and 2

Table 2 shows the list of ingredients for all Comparative Examples and Examples. Table 3 shows the powder blend preparation conditions. Table 4 shows the recipes and the test results.

The validation test for fluidized bed manufacturing is the Wire Melt Characteristic Test, in which a wire sample is preheated for 6 minutes at 343° C. in an oven. The wire is removed from the oven and dipped for six to ten seconds in the fluidized bed containing the powder blend of each example. After those six seconds, the coated wire part is heated at 240° C. for one minute and then air cooled for 10 minutes before being evaluated visually for proper and complete coated structure and aesthetic appearance.

The validation test for performance is the Heat Stability Test, an exposure of the fully coated wire sample to immersion in a 0.75% aqueous solution of Cascade™ brand detergent for 3 days at 70° C., followed by additional aging at 149° C. for 4 days.

TABLE 2

| Brand Name | Ingredient and Purpose | Commercial Source |
|---|---|---|
| GEON 140x466 | PVC Resin | PolyOne |
| | | Corporation |
| Plas-Chek 775 | Epoxidized Soybean Oil | Ferro Corporation |
| | Plasticizer | |
| DPHP | Di(2-Propyl Heptyl) | BASF |
| | Phthalate Plasticizer | |
| OMG OCTYL | Octyl Tin Heat Stabilizer | OMG Group |
| TIN-FDA (2807) | | |
| SYN 1608 | Calcium Zinc Heat Stabilizer | Ferro Corporation |
| TI-PURE ® R- | Rutile titanium dioxide | DuPont |
| 960-07 | pigment | |
| PLASTISTAB | Phosphite Processing Aid | Halstab |
| 2936 | | |
| RA928 | Difunctional bisphenol A/ | Royce International |
| | epichlorohydrin derived | |
| | liquid epoxy resin | |
| EPON 828 | Difunctional bisphenol A/ | Momentive |
| LIQUID | epichlorohydrin derived | |
| | liquid epoxy resin | |
| SR 350K | Trimethylolpropane | Sartomer |
| | trimethacrylate Curing Agent | |
| VINNOLIT P70 | Microsuspension PVC | Vinnolit |
| | homopolymer | |
| PIGMENT | Channel Black Pigment | American Colors |

TABLE 3
Powder Batch Preparation Conditions
All Examples

| | |
|---|---|
| Equipment Type | Henschel Mixer With Cooling Mixer |
| Order of Addition | Ingredients in Table 2 show the order of |
| | addition, with some ingredients not being |
| | present in each Comparative Example or |
| | Example |
| Temperature(s) | Heating and mixing with SR350K |
| | addition at 86° C.; Drop from Henschel at |
| | 100° C.; then Vinnolit P70 addition in the |
| | cooling mixer at 60° C.; and drop at 30° C. |
| RPM of Mixing | Speed set at 8 per lab equipment |

TABLE 4

| Example (in Parts) | A | B | C | 1 | D | 2 |
|---|---|---|---|---|---|---|
| GEON 140x466 | 48.78 | 48.78 | 50.51 | 62.5 | 60.98 | 62.02 |
| Plas-Chek 775 | 4.88 | 4.88 | 1.52 | 1.88 | 1.83 | 1.86 |
| DPHP | 4.88 | 0 | 0 | 0 | 0 | 0 |
| SR350 | 29.27 | 34.15 | 35.35 | 25 | 24.39 | 24.81 |
| OMG OCTYL TIN-FDA (2807) | 0 | 0 | 0 | 1.25 | 1.83 | 1.86 |
| SYN 1608 | 2.44 | 2.44 | 2.53 | 0 | 0 | 0 |
| TI-PURE ® R-960-07 | 2.44 | 2.44 | 2.53 | 3.13 | 3.05 | 3.10 |
| P70 | 4.88 | 4.88 | 5.05 | 3.13 | 3.05 | 3.10 |
| RA928 | 2.44 | 2.44 | 2.53 | 3.13 | 0 | 3.10 |
| EPON 828 LIQUID | 0 | 0 | 0 | 0 | 3.66 | 0 |
| PLASTISTAB 2936 | 0 | 0 | 0 | 0 | 1.22 | 0 |
| | 0 | 0 | 0 | 0 | 0 | 0.16 |
| Total | 100 | 100 | 100 | 100 | 100 | 100 |

Test Results

| | | | | | | |
|---|---|---|---|---|---|---|
| Wire Melt Characteristic Test | Failed | Failed | Failed | Passed | Passed | Passed |
| Heat Stability Test | Failed | Failed | Failed | Passed- | Failed | Passed- |
| | | | | 1 cycle | | 1 cycle |
| Hardness (Shore A) | | | | 83 | | |
| ASTM D2240 | | | | | | |
| Tensile Strength (psi) | | | | 2700 | | |
| ASTM D412 | | | | | | |
| Tensile Elongation (%) | | | | 125 | | |
| ASTM D412 | | | | | | |
| Average Particle Size (μm) | | | | 118 | | |
| ASTM D1921 | | | | | | |

Table 4 shows that Examples 1 and 2 and Comparative Example D were superior to Comparative Examples A-C because they passed the Wire Melt test. Comparative Examples failed the Wire Melt test because the blend re-melted during the curing process and left an uneven coating on the metal substrate. Conversely, Examples 1 and 2 and Comparative Example D passed the Wire Melt test. The difference in type of heat stabilizer distinguished Comparative Examples A-C (calcium zinc heat stabilizer) from Examples 1 and 2 and Comparative Example D (octyl tin heat stabilizer). Therefore, blends of this invention need to avoid the use of calcium zinc heat stabilizer and use octyl tin heat stabilizer.

Among Examples 1 and 2 and Comparative Example D, the difference is the use of the phosphite processing aid. The Heat Stability test demonstrated that blends of this invention need to avoid the use of phosphite processing aids.

Example 1 before the Wire Melt test was also tested for conventional polymer physical properties and found to be acceptable.

Example 2 is preferable to Example 1 because all ingredients are in compliance with FDA 21CFR §175.300, important for use in consumer appliance components.

Another set of experiments probed the minimum amount of trimethylolpropane trimethacrylate needed to produce acceptable Wire Melt Characteristic Tests. Examples 3-6 and Comparative Examples E and F were prepared using the ingredients identified in Table 2 according to the method of Table 3. Table 5 shows the results. Examples 3, 4, and E are the same formulations as Examples 5, 6, and F, respectively.

TABLE 5

| Example | | | | | | |
|---|---|---|---|---|---|---|
| (in Parts) | 3 | 4 | E | 5 | 6 | F |
| PVC Resin | 79.15 | 79.46 | 79.62 | 79.15 | 79.46 | 79.62 |
| GEON 140x466 | | | | | | |
| Plasticizer Plas- | 11.59 | 11.63 | 11.65 | 11.59 | 11.63 | 11.65 |
| Chek 775 | | | | | | |
| Acrylic Monomer | 0.77 | 0.39 | 0.19 | 0.77 | 0.39 | 0.19 |
| SR350 | | | | | | |
| Tin Stabilizer | 1.54 | 1.55 | 1.55 | 1.54 | 1.55 | 1.55 |
| OMG OCTYL | | | | | | |
| TIN-FDA (2807) | | | | | | |
| Pigment TI- | 3.09 | 3.1 | 3.11 | 3.09 | 3.1 | 3.11 |
| PURE ® | | | | | | |
| R-960-07 | | | | | | |
| Epoxy EPON | 3.86 | 3.87 | 3.88 | 3.86 | 3.87 | 3.88 |
| 828 LIQUID | | | | | | |
| Total | 100 | 100 | 100 | 100 | 100 | 100 |

Test Results

| | | | | | | |
|---|---|---|---|---|---|---|
| Wire Melt | Passed | Failed | Failed | Passed | Passed | Failed |
| Characteristic | | | | | | |
| Test | | | | | | |

The trio of Examples 3, 4, and E and the trio of Examples 5, 6, and F demonstrated that the trimethylolpropane trimethacrylate needs to be present in more than about 0.20 weight percent of the blend, in order to pass the Wire Melt Characteristic Test.

Thus, embodiments of the invention can be acceptable also with a minimal amount of trimethylolpropane trimethacrylate present for those circumstances when a minimal amount of trimethylolpropane trimethacrylate is desired.

The invention is not limited to the above embodiments. The claims follow.

What is claimed is:

1. A polymeric blend, comprising:
(a) polyvinyl chloride powder;
(b) trimethylolpropane trimethacrylate;
(c) plasticizer;
(d) octyl tin heat stabilizer;
(e) liquid epoxy resin;
wherein the blend is essentially excludes calcium zinc heat stabilizer and phosphite processing aids.

2. The blend of claim 1, wherein the liquid epoxy resin is difunctional bisphenol A/epichlorohydrin derived liquid epoxy resin.

3. The blend of claim 1 wherein
(a) the polyvinyl chloride powder comprises from about 50 to about 80 weight percent of the blend;
(b) the trimethylolpropane trimethacrylate comprises from about 0.4 to about 50 weight percent of the blend;
(c) the plasticizer comprises from 0.1 to about 12 weight percent of the blend;
(d) the octyl tin heat stabilizer comprises from about 0.1 to about 5 weight percent of the blend;
(e) the liquid epoxy resin comprises from 0.1 to about 10 weight percent of the blend.

4. The blend of claim 1 wherein
(a) the polyvinyl chloride powder comprises from about 55 to about 80 weight percent of the blend;
(b) the trimethylolpropane trimethacrylate comprises from about 0.4 to about 40 weight percent of the blend;
(c) the plasticizer comprises from 0.1 to about 12 weight percent of the blend;
(d) the octyl tin heat stabilizer comprises from about 0.1 to about 2 weight percent of the blend;
(e) the liquid epoxy resin comprises from 0.1 to about 5 weight percent of the blend; wherein the blend further comprises (f) microsuspension polyvinyl chloride homopolymer comprising from about 0.1 to about 5 weight percent of the blend.

5. The blend of claim 1 wherein
(a) the polyvinyl chloride powder comprises from about 60 to about 80 weight percent of the blend;
(b) the trimethylolpropane trimethacrylate comprises from about 0.4 to about 26 weight percent of the blend;
(c) the plasticizer comprises from 1.5 to about 12 weight percent of the blend;
(d) the octyl tin heat stabilizer comprises from about 1 to about 2 weight percent of the blend;
(e) the liquid epoxy resin comprises from 2 to about 4 weight percent of the blend; wherein the blend further comprises
(f) microsuspension polyvinyl chloride homopolymer comprising from about 2 to about 4 weight percent of the blend.

6. The blend of claim 1, wherein average particle size of the polyvinyl chloride powder ranges from about 40 micrometers to about 400 micrometers.

7. The blend of claim 1, wherein average particle size of the polyvinyl chloride powder ranges from about 100 micrometers to about 250 micrometers.

8. The blend of claim 1 coated on a metallic substrate.

9. A coated metal article, comprising a metallic substrate and a coating of the blend of claim 1.

10. The coated metal article of claim 9 in the form of an appliance component.

11. The coated metal article of claim 9 in the form of outdoor furniture.

12. The coated metal article of claim 9 in the form of an automobile part.
